(19) United States
(12) Patent Application Publication
(10) Pub. No.: US 2016/0078183 A1
(43) Pub. Date: Mar. 17, 2016

(54) ELECTRONICALLY PREDICTING CORRECTIVE OPTIONS BASED ON A SENSED PHYSIOLOGICAL CHARACTERISTIC

(71) Applicants: GlaxoSmithKline Intellectual Property Development Limited, Brentford (GB); Community Care of North Carolina, Inc., Raleigh, NC (US)

(72) Inventors: Troy Trygstad, Chapel Hill, NC (US); Alan Menius, Cary, NC (US); Jeffery L. Painter, JR., Raleigh, NC (US)

(73) Assignees: Community Care of North Carolina, Inc., Raleigh, NC (US); GlaxoSmithKline Intellectual Property Development Limited, Brentford (GB)

(21) Appl. No.: 14/824,730

(22) Filed: Aug. 12, 2015

Related U.S. Application Data
(60) Provisional application No. 62/036,855, filed on Aug. 13, 2014.

(51) Int. Cl. G06F 19/00; G06N 5/04

(52) U.S. Cl. CPC G06F 19/345; G06N 5/046

(57) ABSTRACT

A system is provided that can include a processing device and a memory device in which instructions executable by the processing device are stored for causing the processing device to receive sensor data indicating a physiological characteristic of a patient. The instructions can also cause the processing device to electronically transform the sensor data into a risk score representative of a risk to the patient for a negative outcome by applying the physiological characteristic to at least one predictive model received from a predictive model database. The instructions can also cause the processing device to electronically determine a corrective option for reducing the risk by applying the physiological characteristic to a plurality of rules received from a rules database. The instructions can also cause the processing device to configure a display device to output a graphical user interface (GUI) comprising the risk score and the corrective option.

### REFERENCE TO RELATED APPLICATION

This claims priority to U.S. Provisional Patent Application No. 62/036,855, titled “Predictive Models and Rules for Electronically Determining Healthcare Interventions” and filed Aug. 13, 2014, the entirety of which is hereby incorporated by reference herein.

### TECHNICAL FIELD

The present disclosure relates generally to graphical user interfaces displayed by a computing device. More specifically, but not by way of limitation, this disclosure relates to providing graphical user interfaces that include electronically predicted corrective options.

### BACKGROUND

Billions of drug and other medication prescriptions are filled in the United States every year. As a result, the volume and complexity of drug regimens has increased over time, leading to widespread patient non-adherence to drug regimens. The issue of patient non-adherence is often compounded by ill-coordinated and sub-optimal prescribing of drugs. When patients do not adhere to drug regimens, it can place a significant burden on healthcare systems.

In addition, other types of drug therapy problems have proliferated as well. For example, if drug therapies are not optimized or are in conflict with other drugs prescribed to a patient, adverse drug events and sub-optimal responses can occur. In response to these trends, interventions to resolve drug therapy problems have emerged in popularity. But applying an intervention can be complex and cumbersome, and it can be challenging to identify candidates for such interventions.

### SUMMARY

In one example, a system is provided that can include a processing device and a memory device. The memory device can include instructions executable by the processing device for causing the processing device to receive sensor data indicating a physiological characteristic of a patient. The instructions can also cause the processing device to electronically transform the sensor data into a risk score representative of a risk to the patient for a negative outcome by applying the physiological characteristic to at least one predictive model received from a predictive model database. The instructions can also cause the processing device to electronically determine a corrective option for reducing the risk by applying the physiological characteristic to a plurality of rules received from a rules database. The instructions can also cause the processing device to configure a display device to output a graphical user interface (GUI) comprising the risk score and the corrective option.

In another example, a method is provided that can include receiving sensor data indicating a physiological characteristic of a patient. The method can also include electronically transforming the sensor data into a risk score representative of a risk to the patient for a negative outcome by applying the physiological characteristic to at least one predictive model received from a predictive model database. The method can also include electronically determining a corrective option for reducing the risk by applying the physiological characteristic to a plurality of rules received from a rules database. The method can further include configuring a display device to output a graphical user interface (GUI) comprising the risk score and the corrective option.

In another example, a computer readable medium comprising program code executable by a processing device is provided. The program code can cause the processing device to receive sensor data indicating a physiological characteristic of a patient. The program code can also cause the processing device to electronically transform the sensor data into a risk score representative of a risk to the patient for a negative outcome by applying the physiological characteristic to at least one predictive model received from a predictive model database. The program code can also cause the processing device to electronically determine a corrective option for reducing the risk by applying the physiological characteristic to a plurality of rules received from a rules database. The program code can further cause the processing device to configure a display device to output a graphical user interface (GUI) comprising the risk score and the corrective option.

### BRIEF DESCRIPTION OF THE DRAWINGS

FIG. 1 is a block diagram of an example of a system for electronically predicting corrective options based on a sensed physiological characteristic according to some aspects.

FIG. 2 is a block diagram of an example of a computing device for electronically predicting corrective options based on a sensed physiological characteristic according to some aspects.

FIG. 3 is a flow chart of an example of a process for electronically predicting corrective options based on a sensed physiological characteristic according to some aspects.

FIG. 4 is a flow chart of an example of a process for electronically predicting a risk score representing the sensed physiological characteristic according to some aspects.

FIG. 5 is a flow chart of an example of a process for electronically determining one or more corrective options for changing the sensed physiological characteristic according to some aspects.

FIG. 6 is an example of a graphical user interface (GUI) for indicating the risk score and one or more corrective options according to some aspects.

FIG. 7 is an example of a GUI for indicating a patient ranking comparison according to some aspects.

FIG. 8 is an example of a GUI for indicating logistical information according to some aspects.

FIG. 9 is another example of a GUI for indicating logistical information comparison according to some aspects.

### DETAILED DESCRIPTION

Certain aspects and features of the present disclosure relate to a system for providing graphical user interfaces indicating electronically predicted corrective options determined using computing devices distributed over a network. In some examples, a corrective option (e.g., a healthcare intervention) can include an approach usable by a healthcare professional to help a patient overcome a particular health risk. The system can determine the corrective options by applying predictive analytics to one or more physiological characteristics (e.g., a biological, medical, or other physical characteristics of the patient) of the patient as detected by a sensor. Predictive analytics can include applying current and historical data to various models to make predictions about future events.

In some examples, the system can additionally or alternatively determine the corrective options based at least in part on a rule set. The system can apply patient information, one or more physiological characteristics, a risk score (described in greater detail below), results from one or more models, known medication therapy problems input by previous users, or any combination of these to a rule set to determine the corrective options. Corrective options can include both drug and non-drug related interventions, such as social supports, post-surgical and post-hospitalization transitions of care, palliative care supports, and behavioral health interventions. In some examples, a corrective option can include: (i) an optimal setting for care, such as a hospital or nursing home; (ii) an optimal provider or group of providers to deliver the corrective option; (iii) the licensure of the provider of the corrective option; (iv) a type of the corrective option, such as medication therapy; (v) the duration of the implementation of the corrective option; (vi) any necessary follow-up consultations once the corrective option is completed; (vii) the level of intensity of the corrective option; (viii) the modality of the corrective option, or any combination of these.

In some examples, the system can provide the corrective options to healthcare professionals via a graphical user interface. Some examples can allow healthcare professionals to identify, prioritize, and deliver individualized care to patients who demonstrate a need for intervention, for example, due to medication adherence issues, medication discrepancies, and general medication therapy problems. This can increase the patient's chances for successful treatment and reduce the cost of delivering care.

In some examples, the system can use predictive analytics to generate a risk score for the patient. The risk score can include a number symbolizing the patient's overall health or a risk of a negative healthcare outcome for the patient. The system can determine which models, and which data, to use to generate the risk score. Examples of data usable by the system to generate the risk score can include: (i) sensed physiological characteristics; (ii) the patient's prescription fill history; (iii) the patient's hospital admission and discharge data; (iv) the patient's lifestyle behaviors; (v) the patient's known medication therapy or adherence problems; (vi) the patient's likelihood of having a particular disease; (vii) the state of a disease which the patient may have; (viii) patient medical insurance claims; and (ix) any other information relevant to determining or diagnosing a patient's health. The data can also include information associated with other patients. For example, the data can include any of the above types of information associated with other patients.

The risk score can be weighted (e.g., calibrated) or unweighted. When unweighted, the risk score can represent an absolute evaluation of the risk a patient has for a particular negative healthcare outcome. When weighted against a data set, the risk score can represent a relative risk to the patient versus a defined group for a particular negative healthcare outcome. For example, the system can calibrate a patient's risk score against an average risk score for the general population (or a subset of the general population). In some examples, transforming physical patient attributes or symptoms (as detected by a sensor, such as a blood pressure sensor) into a risk score can allow healthcare providers to holistically capture and interpret a patient's physical symptoms and overall health. The risk score can guide an interventionist or administrator in making healthcare decisions for the patient.

In some examples, the system can improve healthcare management systems by allowing healthcare providers to quickly and efficiently identify, rank, and treat patients that may be at risk for a particular negative healthcare outcome. For example, the system can allow a medical provider (e.g., a physician, pharmacist, or nurse) to readily analyze a population of patients and determine the types and likelihoods of drug therapy problems that might exist. This can lead to more successful treatments and lower healthcare costs for healthcare providers and the general public. Additionally or alternatively, some examples can simplify the coordination of an implementation of a corrective option among multiple healthcare providers. This can lead to more efficient use of resources and a more successful treatment for the patient.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

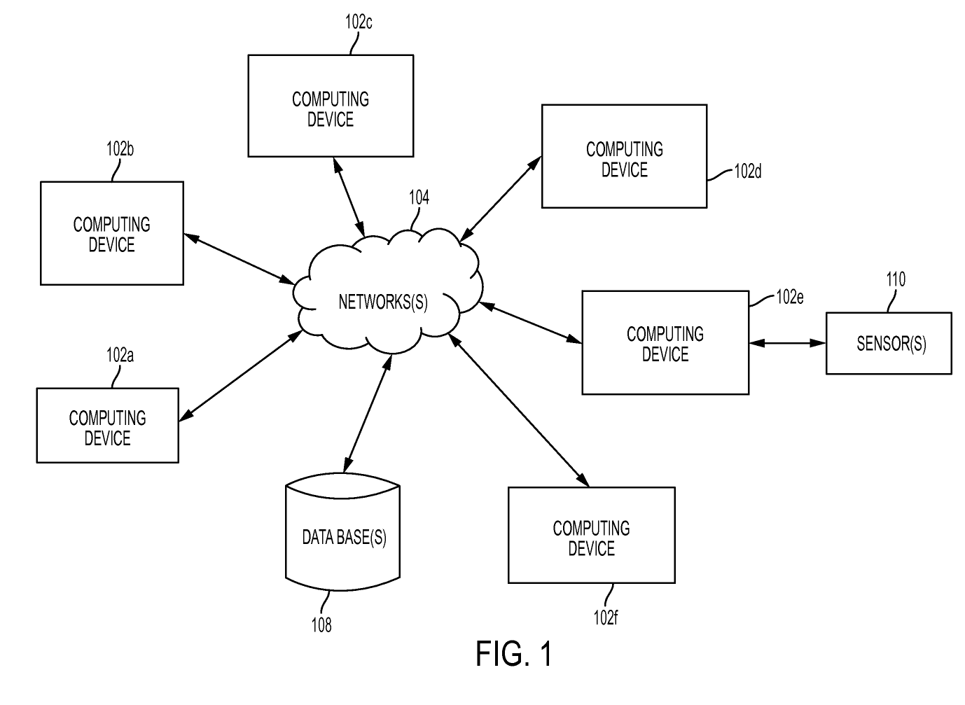

FIG. 1 is a block diagram of an example of a system for electronically predicting corrective options based on a sensed physiological characteristic according to some aspects. The system can include one or more computing devices 102a-f. In some examples, a computing device 102a-f can be associated with a healthcare provider or a patient. For example, computing device 102a can be associated with a patient, computing device 102b can be associated with a hospital, computing device 102c can be associated with an insurance provider, computing device 102d can be associated with a pharmacy or medication provider, and computing device 102e can be associated with a medical office. In some examples, a computing device 102f can include a server for processing data, storing data, or otherwise performing various aspects of examples of the present disclosure.

Various components of the system can be in wireless or wired communication via a network 104. The network 104 can include any suitable number or type of networks or links, including, but not limited to, a dial-up network, a local area network (LAN), wide area network (WAN), public switched telephone network (PSTN), a cellular network, a WiFi network, the Internet, an intranet or any combination of hard-wired and/or wireless communication links. In some examples, the network 104 is a single network. In other embodiments, the network 104 can include two or more networks.

In some examples, the system can include a sensor 110. The sensor 110 can include a medical device for detecting a physiological characteristic of a user. For example, the sensor 110 can include a blood pressure sensor, an electrocardiogram (ECG) device, a pressure sensor, a force sensor, a magneto-resistive sensor, a temperature sensor, an oxygen sensor, an X-ray device, a magnetic resonance imaging (MRI) device, a pulse sensor, a galvanic skin response sensor, an airflow sensor, a heart rate sensor, or any combination of these. In some examples, the sensor 110 can be in wired or wireless communication with a computing device 102a-f via the network 104. In other examples, such as the example shown in FIG. 1, the sensor 110 can be in direct communication with a computing device 102e. The sensor 110 can transmit sensor data to a computing device 102a-f.

In some examples, the system can include one or more database(s) 108. For example, the system can include a predictive model database, a rules database, and a configuration database. In some examples, the predictive model database can store one or more predictive models, the rules database can store one or more rule sets, and the configuration database can store one or more parameters usable to configure a rule set from the rules database. In some examples, a computing device 102a-f can query the database 108 to obtain information for further processing. For example, a computing device 102a-f can query the database 108 to obtain a predictive model or a rule set. Additionally or alternatively, a computing device 102a-f can store information within the database(s) 108. For example, the computing device 102e can receive sensor data from sensor 110 and transmit the sensor data to the database 108 via the network 104. The database 108 can receive the sensor data and store the sensor data.

The system can include any number of computing devices 102a-f and any number of processors. For example, multiple computing devices 102a-f or multiple processors can be distributed over the network 104. In some examples, the system can provide for distributed computing over the network 104. For example, the multiple computing devices 102a-f or multiple processors can perform various aspects of examples of the present disclosure individually or in coordination with one another. This can reduce the processing cost to any individual computing device 102a-f or processor. In some examples, a central server (e.g., computing device 102f can perform various aspects of the present disclosure and provide an output to a computing device 102a-e over the network 104. This can reduce the processing load for the computing device 102a-e.

In some examples, the system can provide for distributed storage of information over the network 104. Any combination of databases 108 and computing devices 102a-f can be used to store information. For example, a predictive model database can be stored on computing device 102b, a rules database can be stored on computing device 102c, and a configuration database can be stored in database 108. A computing device 102a can access portions of the predictive model database, the rules database, and the configuration database by sending queries over the network 104. This can reduce the amount of information stored locally on the computing device 102a.

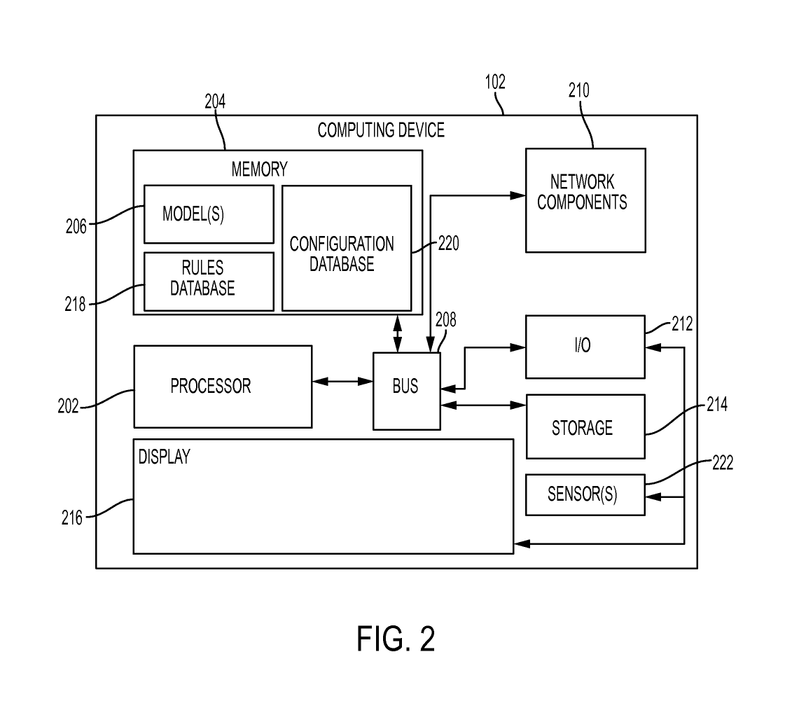

FIG. 2 is a block diagram of an example of a computing device 102 for electronically predicting corrective options based on a sensed physiological characteristic according to some aspects. The computing device 102 can be or include, for example, a laptop computer, desktop computer, tablet, e-reader, smart phone or mobile device, or other electronic device.

The computing device 102 can include a processor 202, a memory 204, and a bus 208. Although FIG. 2 depicts a single processor 202, the computing device 102 can include or be in communication with any number of processors 202. The processor 202 can execute one or more operations for electronically predicting corrective options based on a sensed physiological characteristic. The processor 202 can execute instructions stored in the memory 204 to perform the operations. The processor 202 can include one processing device or multiple processing devices. Non-limiting examples of the processor 202 include a Field-Programmable Gate Array (“FPGA”), an application-specific integrated circuit (“ASIC”), a microprocessor, etc.

The processor 202 can be communicatively coupled to the memory 204 via the bus 208. The non-volatile memory 204 may include any type of memory device that retains stored information when powered off. Non-limiting examples of the memory 204 include electrically erasable and programmable read-only memory (“EEPROM”), flash memory, or any other type of non-volatile memory. In some examples, at least some of the memory 204 can include a medium from which the processor 202 can read instructions. A computer-readable medium can include electronic, optical, magnetic, or other storage devices capable of providing the processor 202 with computer-readable instructions or other program code. Non-limiting examples of a computer-readable medium include (but are not limited to) magnetic disk(s), memory chip(s), ROM, random-access memory (“RAM”), an ASIC, a configured processor, optical storage, or any other medium from which a computer processor can read instructions. The instructions can include processor-specific instructions generated by a compiler or an interpreter from code written in any suitable computer-programming language, including, for example, C, C++, C#, etc.

In some examples, the memory 204 can include one or more models 206. A model 206 can include one or more algorithms configured to electronically predict a parameter associated with a physiological characteristic of a patient. For example, the model(s) 206 can predict a risk score representing a risk of a negative healthcare outcome for a patient, a corrective option for decreasing the risk, or both. In some examples, a model can be generated by applying statistical techniques to data (e.g., healthcare data) associated with one or more groups of patients. An example of a model 206 can include the following algorithm:

Probability(Drug_Therapy_Problem_Related_To_Therapeutic_Consideration)=1/(1+(X₁*AHFS_DrugClasses+X₂*AdmissionsData+X₃*AcuteMedicationCount+X₄*ChronicMedCount+X₅*HighRiskMedCount)̂exp(−1))

where Probability(Drug_Therapy_Problem_Related_To_Therapeutic_Consideration) can represent a probability that a patient will experience a drug therapy problem associated with an issue of therapeutic consideration, such as the patient's socioeconomic status or the patient's access to a drug; AHFS_DrugClasses can represent a positive or negative value indicating one or more drugs of interest that were prescribed to a patient in a specific time period (e.g., 12 months); AdmissionsData can represent a number of times a patient has been admitted to a hospital setting within a specific time period; AcuteMedicationCount can represent a number of times an acute medication prescription was filled within a specific time period; ChronicMedCount can represent a number of times a chronic medication prescription was filled within a specific time period; HighRiskMedCount can represent a number of times a high-risk medication prescription was filled within a specific time period; and X₁ through X₅ can each represent a coefficient for weighting an associated parameter (e.g., X₁ can represent a coefficient for weighting AHFS_DrugClasses).

In some examples, the memory 204 can include a rules database 218. The rules database 218 can include one or more sets of rules. The sets of rules can be defined or developed by a clinical team or a healthcare provider and input into the computing device 102. The computing device 102 can apply one or more rules from the rules database 218 to data associated with the patient to determine one or more corrective options. In some examples, the sets of rules can include one or more logical expressions.

In some examples, the memory 204 can include a configuration database 220 (e.g., a lookup table). The configuration database 220 can be defined or developed by a clinical team or a healthcare provider and input into the computing device 102. The configuration database 220 can include information such as, for example, false positive rates, false negative rates, an average duration of a corrective option, a cost per unit of time per healthcare professional in a particular healthcare location (“actor-setting”), an actor-setting workforce status, positive predictive values, and other information. The computing device 102 can access one or more configuration databases 220 to configure the rules database 218. For example, the computing device 102 can calibrate a rule set from the rules database 218 using one or more parameters stored in the configuration database 220.

The computing device 102 can include input/output (“I/O”) interface components 212 and additional storage 214. For example, the I/O interface components 212 can interface with a display 216, sensor 222, keyboard, mouse, joystick, touch-screen, additional storage 214, or any combination of these. The display 216 can include a television, computer monitor, liquid crystal display (LCD), or any other suitable display device.

In some examples, the computing device 102 can include network components 210. Network components 210 can represent one or more of any components that facilitate a network connection. In some embodiments, the network components 210 can facilitate a wireless connection and include wireless interfaces such as IEEE 802.11, Bluetooth, or radio interfaces for accessing cellular telephone networks (e.g., a transceiver/antenna for accessing CDMA, GSM, UMTS, or other mobile communications network). In other embodiments, the network components 210 can be wired and can include interfaces such as Ethernet, USB, or IEEE 1394.

The computing device 102 can in communication with one or more sensor(s) 222. The sensor(s) 222 can be directly coupled to the computing device 102, such as with a wire, or the computing device 102 can be in communication with the sensor(s) 222 over a network (e.g., the network 104 of FIG. 1). In some examples, the sensor(s) 222 can include a blood pressure sensor, an electrocardiogram (ECG) device, a pressure sensor, a force sensor, a magneto-resistive sensor, a temperature sensor, an oxygen sensor, an X-ray device, a magnetic resonance imaging (MRI) device, a pulse sensor, a galvanic skin response sensor, an airflow sensor, a heart rate sensor, or any combination of these. The sensor(s) 222 can detect one or more characteristics of a patient and transmit sensor signals associated with the characteristics to the processor 202. In other examples, the sensor(s) 222 can include a user input device. For example, the sensor(s) 222 can include a mouse, keyboard, stylus, touch-screen display, touch pad, or any combination of these. The sensor(s) 222 can detect a user input and transmit sensor signals associated with the user input to the processor 202.

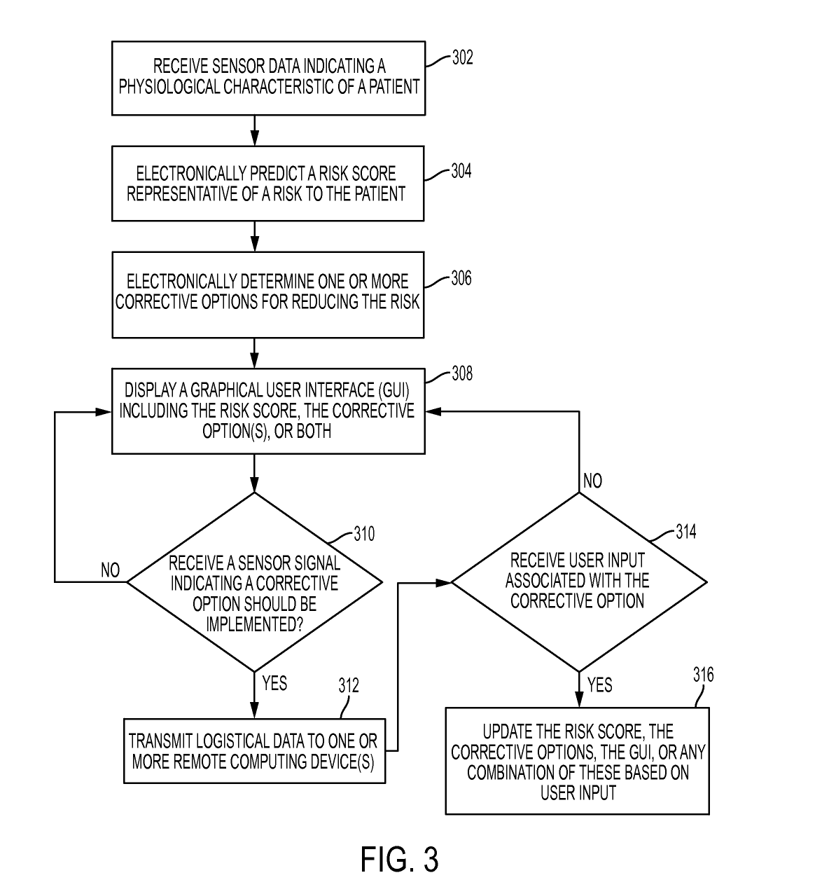

FIG. 3 is a flow chart of an example of a process for electronically predicting corrective options based on a sensed physiological characteristic according to some aspects. Some examples can include more, fewer, or different steps than the steps depicted in FIG. 3. The steps below are described with reference to components described above with regard to computing device 102 shown in FIG. 2.

In block 302, the computing device 102 receives sensor data indicating a physiological characteristic of a patient. The computing device 102 can receive the sensor data from a sensor 222 via a wired or wireless communication. The sensor data can include a blood pressure, an electrocardiogram, a pressure, a force, a temperature, an oxygen level, an X-ray, a MRI result, a pulse sensor, an airflow level, a heart rate, or any combination of these. In some examples, the sensor data can include medical information, a health history, a medical treatment history, physiological information, health care utilization information, psychosocial information, demographical information, environmental information, or any combination of these. The sensor data can be input by the patient, a healthcare provider, or both. For example, the sensor data can include medical records associated with the patient and input by the patient's healthcare provider. The sensor data can include any information relevant to determining or diagnosing the patient's health.

In block 304, the computing device 102 electronically predicts a risk score representative of a risk to the patient. The computing device 102 can electronically predict the risk score based on the physiological characteristic and/or other sensor data. In some examples, the risk score can include a number symbolizing a risk of a negative healthcare outcome for the patient or the patient's overall health (e.g., medical health).

In some examples, the computing device 102 can apply the physiological characteristic to one or more predictive models to determine the risk score. Additionally or alternatively, the computing device 102 can apply an age, gender, ethnicity, medical condition, prescribed drug, procured drug, compliment from a prescriber, compliment of acute drugs, compliment of chronically used drugs, a prior hospitalization, a prior emergency department visit, or any combination of these to one or more predictive models to determine the risk score. Additionally or alternatively, the computing device 102 can apply one or more psychosocial factors (e.g., a patient's belief in the efficacy of a medication, an awareness of the patient to a medical condition, a health literacy of the patient, an amount of knowledge the patient has about a medication, the stability of the patient's overall life, or any combination of these) to the one or more predictive models to determine the risk score. Additionally or alternatively, the computing device 102 can apply one or more socio-demographic factors (e.g., a barrier to accessing a medication, such as a high cost, a lack of transportation, a payer type, or any combination of these) to the one or more predictive models to determine the risk score.

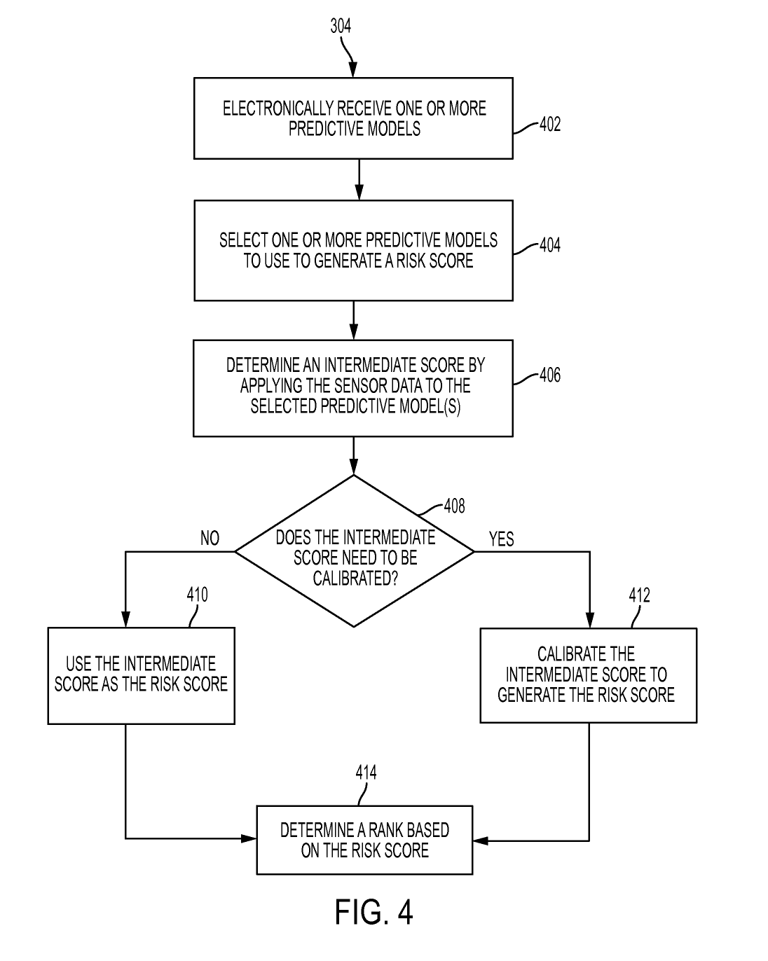

In some examples, the computing device 102 can determine what data is needed and/or available for predicting the risk score. The computing device 102 can obtain the necessary and/or available data and apply the data to the one or more models to predict the risk score. In some examples, the computing device 102 can perform any combination of the steps shown in FIG. 4 to predict the risk score.

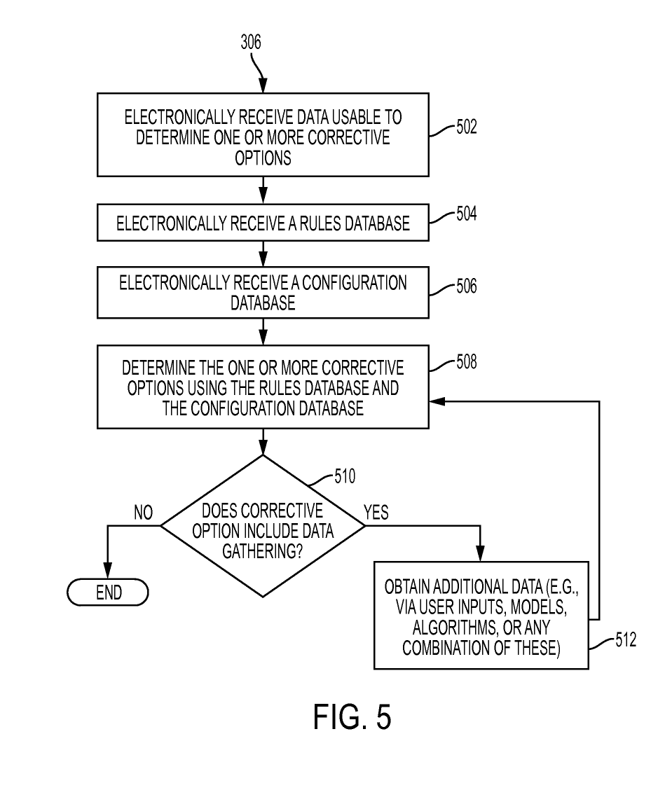

In block 306, the computing device 102 determines one or more corrective options for reducing the risk (e.g., to the patient). For example, the computing device 102 can apply the sensor data, the physiological characteristic, or both to one or more predictive models to determine one or more predicted characteristics of the patient. The computing device 102 can apply the one or more predicted characteristics to a rules set (e.g., from rules database 218) to determine one or more corrective options. As another example, the computing device 102 can perform any combination of the steps shown in FIG. 5 to determine the one or more corrective options.

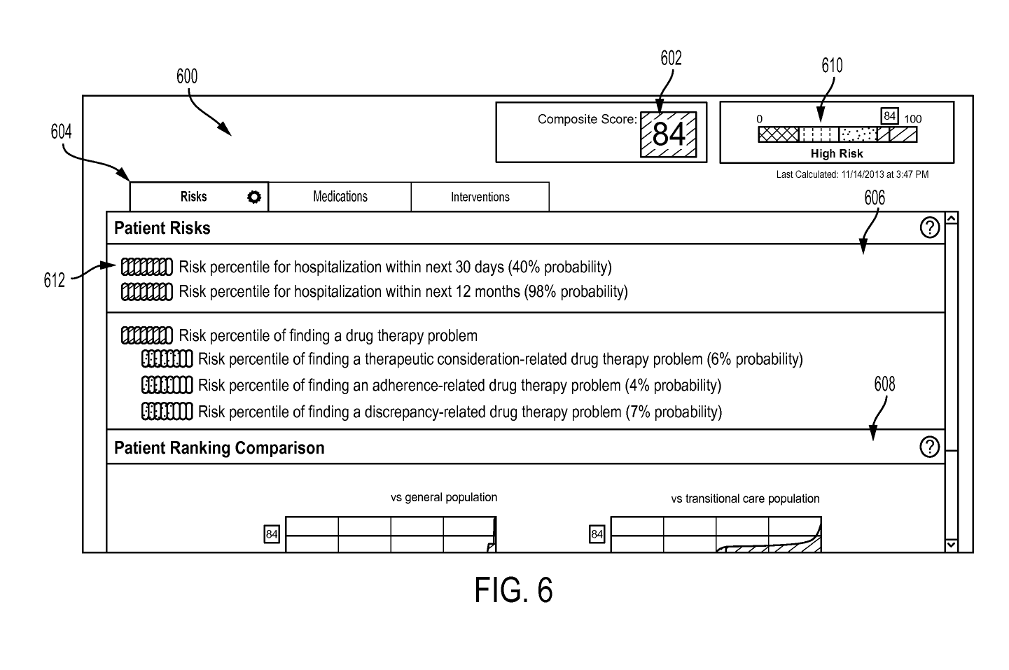

In block 308, the computing device 102 displays a graphical user interface (GUI) via the display 116. The GUI can include the risk score, the one or more corrective options, or both. The graphical user interface can include other information and one or more lists, icons, images, charts, or graphs, for example, as described in further detail below with respect to FIGS. 6-9.

In block 310, the computing device 102 determines if the computing device 102 has received a sensor signal indicating that a corrective option should be implemented. For example, the computing device 102 can receive a sensor signal from an input device (e.g., a mouse, keyboard, or touch-screen display) indicating that a user has interacted with or selected a particular GUI component. For example, the computing device 102 can receive a sensor signal indicating that a user interacted with a particular virtual button, slider, knob, or other GUI component. The GUI component can be associated with implementing one or more of the corrective options. The computing device 102 can receive the sensor signal and determine that a corrective option should be implemented based on the sensor signal.

If the computing device 102 receives the sensor signal indicating the corrective option should be implement, the process can continue to block 312. Otherwise, the process can return to block 308.

In block 312, the computing device 102 transmits logistical data to one or more remote computing device(s). The logistical data can include information for implementing at least a portion of a corrective option. In some examples, the logistical data can include the corrective option, an assignment of a portion of the corrective option to be implemented, a date and time for a treatment, personnel for performing the treatment, a healthcare center to provide the treatment, a delivery schedule (e.g., for medications, products, medical tools, etc.), a medication to be used in the treatment, a chemical to be used in the treatment, a medical tool to be used in the treatment, or any combination of these. In some examples, the corrective option can include gathering data about the patient. The logistical data can include a coordination among one or more healthcare providers for gathering the data about the patient.

In some examples, multiple healthcare providers can be responsible for implementing different portions of a corrective option. The computing device 102 can transmit logistical data (e.g., over a network) to remote computing devices associated with each of the healthcare entities. The healthcare entities can receive the logistical information via the remote computing devices and implement one or more portions of the corrective option.

In some examples, the remote computing devices can receive the logistical data and automatically update a portion of a patient's medical record with at least a portion of the logistical data. For example, the remote computing device can receive a suggested corrective option for a patient and include the suggested corrective option in the patient's medical record.

For example, the computing device 102 can help coordinate the delivery of medications, treatments, or counseling to the patient. The computing device 102 can coordinate the delivery based on patient information (such as the address or income of the patient); healthcare provider resources (such as which hospitals have the appropriate staff or medications to deliver the intervention); or other information. In some examples, the computing device 102 can transmit logistical information to the remote computing device(s) including a role (e.g., as a primary medication administrator, follow-up consultation provider, or medication provider to the primary medication administrator) for the associated healthcare in the implementation of the corrective option. Coordination of various aspects of the corrective option can ensure that the patient receives care efficiently.

In block 314, the computing device 102 determines if the computing device 102 has received user input associated with a corrective option. In some examples, the computing device 102 can determine that the computing device 102 received the user input based on an input signal provided by a user input device (e.g., a keyboard, mouse, joystick, touch-screen, or other input means). For example, a user, such as healthcare professional, can provide the user input to the computing device 102 via the user input device. In some examples, the computing device 102 can determine that the computing device 102 received the user input in response to receiving a signal associated with the user input from a remote computing device over a network. For example, a user can provide the user input to the remote computing device. The remote computing device can communicate the user input via a network to the computing device 102. In some examples, the user input can be associated with the progression of a corrective option currently being administered to the patient. In some examples, the user input can be additional information usable for determining another corrective option.

If the computing device 102 determines that the computing device 102 received the user input, the process can continue to block 316. Otherwise, the process can return to block 308.

In block 316, the computing device 102 can update the risk score, the corrective options, the GUI, or any combination of these based on the user input. For example, the computing device 102 can update and monitor the risk score or other patient information based on the user input. The computing device 102 can use the user input to determine the impact of the particular corrective option on the patient's health over time. For example, a healthcare professional can input the results of a corrective option delivered to a patient, clinical findings, or other data into the computing device 102 and the computing device 102 can generate a new risk score for the patient. The computing device 102 can compare the new risk score to an old risk score to determine the efficacy or efficiency of the corrective option for the patient. Further, the computing device 102 can use the user input to determine the efficacy or efficiency of a certain corrective option with respect to a particular patient population (e.g., a group of patients with similar medical histories). As the computing device 102 determines which corrective options are successful, unsuccessful, efficient, or inefficient, the computing device 102 can use this information to refine its suggested corrective options (e.g., the computing device can “learn”).

In some examples, the computing device 102 can determine a new or different corrective option based on the user input. For example, the corrective option can include gathering data associated with the patient. The computing device 102 can prompt a user to provide the data associated with the patient. The computing device 102 can receive the user input from the user and use the user input to determine a new or different corrective option.

In some examples, the computing device 102 can receive the user input (e.g., via a data network) from one or more remote computing devices associated with one or more healthcare providers. For example, a healthcare provider can transmit, from a remote computing device, user input associated with the performance of a corrective option. The computing device 102 can receive the user input and mark one or more tasks associated with the corrective option as complete or incomplete (e.g., within the GUI). The computing device 102 can also update patient data, such as a patient's medical record, based on the received user input. The computing device 102 can use the received user input to further refine its suggested corrective options using, for example, any of the methods described above.

FIG. 4 is a flow chart of an example of a process for electronically predicting a risk score representing the sensed physiological characteristic according to some aspects. Some examples can include more, fewer, or different steps than the steps depicted in FIG. 4. The steps below are described with reference to components described above with regard to computing device 102 shown in FIG. 2.

In block 402, the computing device 102 electronically receives one or more predictive models. In some examples, the computing device 102 can receive the predictive models over a network. The computing device 102 can query one or more remote databases and receive one or more predictive models. For example, the computing device 102 can query two remote databases using one or more criteria and receive from the two remote databases two or more predictive models.

In some examples, the computing device 102 can store the predicative models in memory 204 (e.g., as shown as models 206). The computing device 102 can retrieve the predictive models from memory 204.

In block 404, the computing device 102 selects one or more of the predictive models to use to generate a risk score (e.g., based on sensor data, such as a physiological characteristic). For example, the computing device 102 can select a subset of the received predictive models to use to generate the risk score. In some examples, the computing device 102 can select the subset based on sensor data associated with the patient. For example, the computing device 102 can receive at least two predictive models (e.g., from two different remote databases). The computing device 102 can select one of the predictive models to use based on a blood pressure, an electrocardiogram, a pressure, a force, a temperature, an oxygen level, an X-ray, a MRI result, a pulse sensor, an airflow level, a heart rate, or medical history data associated with the patient.

In some examples, the computing device 102 can consult a lookup table or algorithm stored in memory 204 to determine a predictive model to use. The computing device 102 can select from among a list of predictive models or algorithms to determine which predictive model to use. Some predictive models can determine, for example, a patient's likelihood of contracting a disease (e.g., Chronic Obstructive Pulmonary Disease), needing hospitalization or readmission to a hospital, or adhering to a treatment regimen.

In block 406, the computing device 102 determines an intermediate score. The computing device 102 can determine the intermediate score by applying the sensor data (e.g., a physiological characteristic) to the selected predictive model(s). For example, the computing device 102 can apply the sensor data as input variables to one or more algorithms that make up a predictive model. The computing device 102 then performs one or more calculations associated with the predictive model to determine an output value from the predictive model. In some examples, the output from the one or more predictive model(s) can be the intermediate score. The intermediate score can include a raw (e.g., unweighted or uncalibrated) value or a calibrated value.

In block 408, the computing device 102 determines if the intermediate score needs to be calibrated. The computing device 102 can determine if the intermediate score needs to be calibrated based on one or more user inputs. For example, the computing device 102 can receive a sensor signal associated with a user interaction with a GUI component. The GUI component can be for calibrating or weighting the intermediate score. The computing device 102 can determine that the intermediate score needs to be calibrated, or does not need to be calibrated, based on the sensor signal.

If the computing device 102 determines that the intermediate score does not need to be calibrated, the process continues to block 410. In block 410, the computing device 102 uses the intermediate score as the risk score. Otherwise, the process continues to block 412.

In block 412, the computing device 102 can calibrate the intermediate score to generate the risk score. In some examples, the computing device 102 can generate the risk score by comparing the intermediate score against an average intermediate score for a subset of the population. As another example, the computing device 101 can generate the risk score by weighting an output from a predictive model, so that the output has more or less influence in determining the risk score.

In block 414, the computing device 102 determines a rank (e.g., for the patient) based on the risk score. In some examples, the computing device 102 can determine the rank for the patient against other patients in the general population, a subset of the general population, or both. For example, the computing device 102 can determine the rank by comparing the risk score to other risk scores associated with the general population, a subset of the general population, or both. The computing device 102 can proscribe a higher rank to the patient in response to the risk score being higher and a lower rank to the patient in response to the risk score being lower, or vice-versa. In some examples, a higher rank can represent a more imminent need for intervention than a lower rank. The computing device 102 can additionally or alternatively determine the rank for the patient based on other configurable criteria, such as the cost to the hospital for treating the patient, the duration of the patient's average hospital stay, the number or rarity of medications proscribed to the patient, or any combination of these. This can allow medical professionals to triage patients to most effectively prioritize their resources among the patients.

FIG. 5 is a flow chart of an example of a process for electronically determining one or more corrective options for changing the sensed physiological characteristic of a patient according to some aspects. Some examples can include more, fewer, or different steps than the steps depicted in FIG. 5. The steps below are described with reference to components described above with regard to computing device 102 shown in FIG. 2.

In block 502, the computing device 102 electronically receives data usable by the computing device 102 to determine one or more corrective options. In some examples, the computing device 102 can receive the data via a network. In other examples, the computing device 102 can store the data in memory 204. In some examples, the data includes the sensor data described with respect to block 302 of FIG. 3.

The computing device 102 can obtain the data from a user, using one or more models, using one or more algorithms, using one or more databases, or any combination of these. In some examples, the data can include psychosocial information associated with a patient, demographical information associated with the patient, or both. In some examples, the data can include a flag indicating whether a patient has a particular medical condition, an indication (e.g., a percentage) of a number of days in a predefined period of time for which the patient has an adequate amount of medication (e.g., for controlling one or more symptoms of the medical condition), an indication of a number of days in a predefined period of time for which the patient has an inadequate amount of medication, a date that the medication was filled within a predefined time period (e.g., one year), a number of times the medication was filled within a predefined period of time (e.g., one year), or any combination of these.

In some examples, the computing device 102 can generate the data using multiple algorithms or multiple models. For example, the computing device 102 can provide different data as an input to a first model, and provide the output of the first model as an input to a second model. The output of the second model can be the data. In some examples, the computing device 102 can generate the data by iterating a model or an algorithm multiple times. For example, the computing device 102 can generate the data by iterating a model multiple times, using an output from the model as the input for a subsequent iteration of the model.

In block 504, the computing device 102 electronically receives a rules database. In some examples, the computing device 102 can receive the rules databased via a network. In other examples, the computing device 102 can store the rules database in memory 204 (e.g., rules database 218). The rules database can be defined or developed by a clinical team or a healthcare provider and input into the computing device 102.

In some examples, the rule database can map or associate healthcare resources, corrective options, health risk scores, or other data to or with one another. For example, a rule set of the rules database can map medication therapy problems with specific suggested corrective options.

In some examples, a rule set of the rules database can include one or more logical expressions. For example, a rule set can include the following logical expression:

IF(AsthmaDiagnosis=true AND (AsthmaControllerPDC<=0.8 OR GapAsthmaControllerTherapy>=45days OR DateOfSingleAsthmaControllerFill>=Today−45 OR CountAsthmaControllerFillsInPastYr=0) AND Count4+BetaAgonistFillsIn90DaysOverPast6Months=true) THEN SET resultVar=true

where AsthmaDiagnosis can indicate if the patient has an asthma diagnosis, AsthmaControllerPDC can represent a percentage of days over a predefined period of time covered by an asthma controlling medication, GapAsthmaControllerTherapy can represent a gap in the predefined period of time not covered by the asthma controlling medication, DateOfSingleAsthmaControllerFill can represent a date of a single fill of the asthma controlling medication within the past year, CountAsthmaControllerFillsInPastYr can represent the number of fills of the asthma controlling medication in the past year, Count4+BetaAgonistFillsIn90DaysOverPast6Months can indicate if the patient has filled a beta agonist medication (e.g., an inhaler medication) in a 90-day interval during the past 6 months, and resultVar can indicate the result of the logical expression. The computing device 102 can apply the data to the logical expressions to determine one or more outputs from the rule set.

In some examples, a rule set can include multiple logical expressions. The computing device 102 can apply the output from one logical expression as an input to another logical expression. For example, a rule set can include the following logical expression:

IF resultVar=true AND PatientAttributedToOnePharmacy=true THEN ProvideCorrectiveOption7

where resultVar can be the output of the first logical expression discussed above, PatientAttributedToOnePharmacy can indicate if the patient uses one pharmacy, and ProvideCorrectiveOption7 indicates that corrective option number 7 should be provided.

In some examples, the rules database can be, at least in part, user configurable. For example, the logical expressions and/or the sequence in which multiple logical expressions should be executed can be configured by a user. This can allow the user to tailor various aspects due to budgetary constraints, administrative constraints, medical constraints, patient constraints, or any other constraint or combination of constraints.

In block 506, the computing device 102 electronically receives a configuration database. In some examples, the computing device 102 can receive the configuration database via a network. In other examples, the computing device 102 can store the configuration database in memory 204 (e.g., configuration database 220).

In some examples, the configuration database can include one or more parameters usable for configuring the rules database (e.g., a rule set within the rules database). For example, the configuration database can include data usable as inputs for variables in a logical expression of the rules database. The computing device 102 can apply data from the configuration database as one or more input parameters for a rule set from the rules database to configure the rule set.

The configuration database can additionally or alternatively include one or more lookup tables. The computing device 102 can use the lookup tables to map outputs from the rules database (e.g., a logical expression) to other information. For example, the configuration database can include a lookup table usable to determine high-level patient concerns (e.g., a generalized medication management issue), categories of patient concerns (e.g., medication adherence concerns, potential medication discrepancies, or medication optimization issues), sub-categories of patient concerns (e.g., patient lacks a medication, patient has a physical impairment, patient is potentially misusing medication, there is a medication discrepancy of patient or healthcare-provider origin, or there is a medication optimization problem due to an unneeded medication or incorrect dosage), particular patient issues (e.g., the patient cannot afford the medication, the patient needs a medication refill, the patient's medication regimen is too complex, the patient cannot remember to take the medication, or the patient has a drug allergy), or any combination of these. The computing device 102 can select among the high-level patient concerns, categories of patient concerns, sub-categories of patient concerns, and/or particular patient issues based on an output of a rule set from the rules database.

As another example, the configuration database can include a lookup table usable to determine categories of activities to be performed for a particular corrective option (e.g., gathering information; assessing medication adherence; assessing medication discrepancies; performing a follow-up after the corrective option has been implemented; and/or referring the corrective option to a prescriber, pharmacist, nurse, or other healthcare provider), sub-categories of activities to be performed for the particular corrective option (e.g., basic transitional care comprehensive medication review, moderate medication adherence review, complex medication reconciliation, high-level medication overview conducted as part of a hospital visit, and/or an assessment of adverse effects to the corrective option), particular activities to be performed for the corrective option (e.g., gathering a prescription fill history, gathering a social history of the patient, reviewing medication adherence based on prescription fill dates, identifying medication discrepancies, co-developing a care plan with a team, communication information to a prescriber, following up with a prescriber or patient, and/or determining an optimal medication therapy), or any combination of these. The computing device 102 can select among the categories of activities, sub-categories of activities, and/or particular activities based on an output of a rule set from the rules database.

As still another example, the configuration database can include a lookup table usable to determine a priority between multiple healthcare providers for providing at least a portion of the corrective option to the patient. For example, the configuration database can include a lookup table that maps a particular corrective option to a prioritized list of healthcare providers usable for implementing the corrective option. In one example, the lookup table can map a corrective option including a basic medication adherence review to a prioritized list of healthcare providers including, in order from highest priority to lowest priority: (1) a pharmacy technician, (2) a social work care manager, (3) a social worker, (4) a registered nurse care manager, (5) a registered nurse, (6) a pharmacist, and (7) a medication prescriber.

In some examples, the configuration database can be, at least in part, user configurable. For example, the high-level patient concerns, categories of patient concerns, sub-categories of patient concerns, particular patient issues, categories of activities, sub-categories of activities, and/or particular activities can be configured by a user. This can allow the user to tailor various aspects due to budgetary constraints, administrative constraints, medical constraints, patient constraints, or any other constraint or combination of constraints.

In block 508, the computing device 102 determines one or more corrective options. The computing device 102 can determine the corrective option(s) using the rules database, the calibration database, or both. For example, the computing device 102 can apply the data, the physiological characteristic, an output from a predictive model, a risk score, a patient rank, or any combination of these as input to a rule set from the rules database. The computing device 102 can map an output from the rule set to one or more corrective options using a lookup table of the configuration database. The one or more corrective options can include, for example, administering a medication, an optimal care setting in which to administer the medication, a prioritized list of healthcare providers to administer the medication, or any combination of these.

As a particular example, the computing device 102 can receive data including a risk score for a patient and a threshold value (e.g., 75 on a scale between 0 and 100) for the risk score. In some examples, the computing device 102 can receive the risk score from a model and the threshold value from the configuration database. The computing device 102 can receive a rule set including the following logical expression:

IF RiskScore>Threshold THEN SET CareTriageRiskScoreOverThreshold=true AND ProvideCorrectiveOption9

where RiskScore indicates the risk score for the patient, Threshold indicates the threshold value for the risk score, and ProvideCorrectiveOption9 indicates that corrective option number 9 should be provided. The computing device 102 can apply the data to the rule set to determine a corrective option. For example, if the RiskScore exceeds the Threshold, the computing device 102 can determine the corrective option number 9 should be provided. In some examples, the computing device 102 can use the configuration database to determine one or more particular actions associated with corrective option number 9. For example, the computing device 102 can use a lookup table of the configuration database to map corrective option number 9 to one or more specific actions. An example of a specific action can include a complex comprehensive medication review. Additionally, the computing device 102 can use a lookup table of the configuration database to map the one or more specific actions to one or more sub-actions. Examples of the sub-actions can include gathering a prescription fill history, gathering an active medication list, gathering a social history of the patient, gathering a medical history, compiling one or more lists, reviewing medication adherence based on one or more prescription fill dates, or any combination of these.

In some examples, the computing device 102 can use a corrective option indicator (e.g., the corrective option number), one or more specific actions, one or more sub-actions, or any combination of these as the one or more corrective options. In some examples, the computing device 102 can determine (e.g., using the configuration database) and include in the corrective option a prioritized list of healthcare providers usable to implement the corrective option.

In block 510, the computing device 102 determines if the corrective option includes data gathering. In some examples, the computing device 102 can determine that the corrective option includes data gathering based on the corrective option itself including a data gathering step. In some examples, the computing device 102 can determine that the corrective option includes data gathering in response to determining that all of the variables in a logical expression of the rules set do not include a value. In some examples, the computing device 102 can determine that the corrective option includes data gathering in response to determining that the computing device 102 lacks one or more required inputs for a model.

If the computing device 102 determines that the corrective option includes data gathering, the process can proceed to block 512. Otherwise, the process can end.

In block 512, the computing device 102 obtains additional data. The computing device 102 can prompt a user to input the additional data, execute one or more algorithms or models to obtain the additional data, query one or more databases to obtain the additional data, or any combination of these. In some examples, the computing device 102 can determine that specific information may be necessary to determine another corrective option. The computing device 102 can prompt the user to input the specific information or otherwise obtain the specific information using, for example, a database. In some examples, the computing device 102 can obtain the additional data by performing the steps of blocks 312-316 of FIG. 3. In some examples, the process can return to block 508 in response to the computing device 102 obtaining the additional data. The computing device 102 can integrate the additional data into other data and/or otherwise use the additional data to determine one or more new corrective options and/or a new risk score.

### Example Graphical User Interfaces

The following examples of graphical user interfaces (GUI) can be output by a computing device (e.g., computing device 102 of FIG. 2) via a display (e.g., display 116 if FIG. 2). The computing device can output the GUIs by executing instructions stored in memory (e.g., memory 204 of FIG. 2).

FIG. 6 is an example of a graphical user interface (GUI) for indicating the risk score and one or more corrective options according to some aspects. In this example, the GUI 600 includes a risk score 602. The risk score 602 can include a numerical value. The risk score 602 can be displayed with, for example, white text against a red, square- or rectangular-shaped background. Additionally or alternatively, the risk score 602 can be associated with a bar meter 610. The bar meter 610 can include risk scores 602 ranging from zero to 100. The bar meter 610 can include any arrangement or number of colors associated with risk scores 602. In this example, the bar meter 610 includes a first color (e.g., green) for the range from zero to 25, a second color (e.g., yellow) for the range from 26 to 50, a third color (e.g., orange) for the range from 51 to 75, and a fourth color (e.g., red) for the range from 76 to 100.

The GUI 600 can include one or more tabs 604, for example, positioned below the risk score 602. The tabs 604 can include a “Risks” tab, a “Medications” tab, an “Interventions” tab, or any other suitable tab. The computing device can detect the user selecting a tab, and in response, display information associated with the tab within the GUI 600.

In the example shown in FIG. 6, the GUI 600 is displaying information 606 associated with the “Risks” tab. The information 606 can be divided into multiple sections. Each section can include a heading bar and the name of the section. For example, the information 606 can include a “Patient Risks” section. The Patient Risks section can include patient risks, such as the likelihood that the patient will be hospitalized in the next 30 days or the next 12 months. One or more bar meters 612 can be positioned adjacent to the patient risks for visually representing patient risk values (e.g., percentage values associated with the likelihood of a patient succumbing to the patient risk). The bar meters 612 can include any arrangement or number of colors associated with the patient risk values.

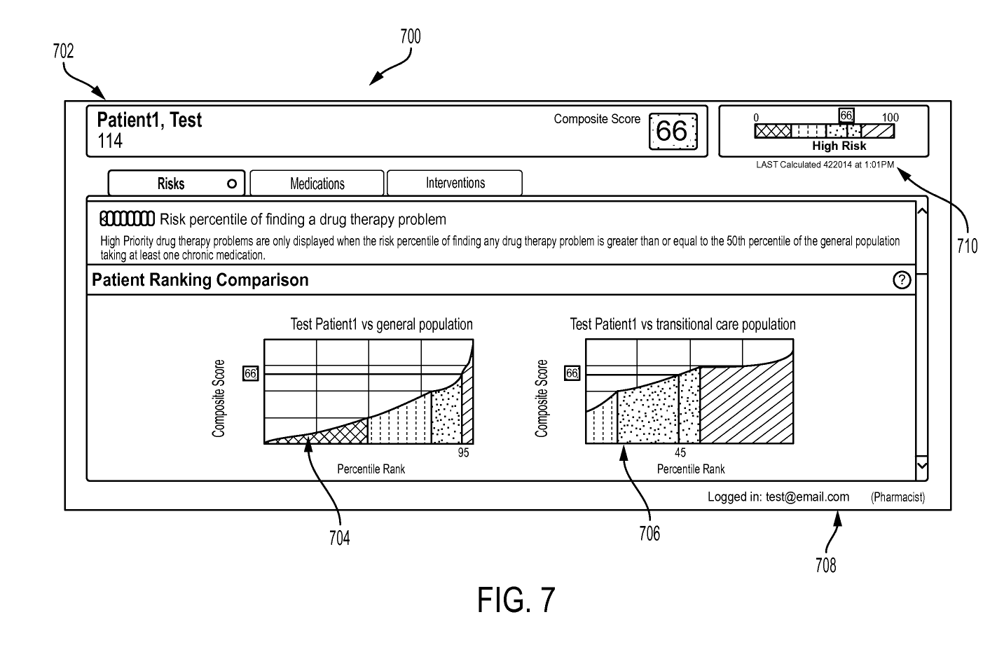

The information 606 can also include a “Patient Ranking Comparison” section 608. The Patient Ranking Comparison section 608 can rank or compare the risk score 602 against the general population or a subset of the population (e.g., a transitional care population). An example of the Patient Ranking Comparison section 608 is shown in further detail with respect to FIG. 7.

FIG. 7 is an example of a GUI 700 for indicating a patient ranking comparison according to some aspects. In this example, the GUI 700 includes the patient's name and other patient information 702 (e.g., a patient number or an identifying number associated with the patient).

The GUI 700 can include one or more graphs or charts. For example, the GUI 700 can include a first graph 704. The first graph 704 can compare the patient's risk score against those of the general population. The GUI 700 can additionally or alternatively include a second graph 706. The second graph 706 can compare the patient's risk score against those of a subset of the general population, in this example a transitional care population. The graphs or charts can include one or more colors. In some examples, the colors can visually represent different percentile ranges. For example, one color can represent a percentile range between 0 and 40% and another color can represent another percentile range between 40% and 75%.

In some examples, the GUI 700 can include information 708 associated with a user, such as a username, e-mail address, role or occupation (e.g., Pharmacist), or other relevant data. The GUI 700 can also include the time and date 710 on which the patient's risk score was last calculated.

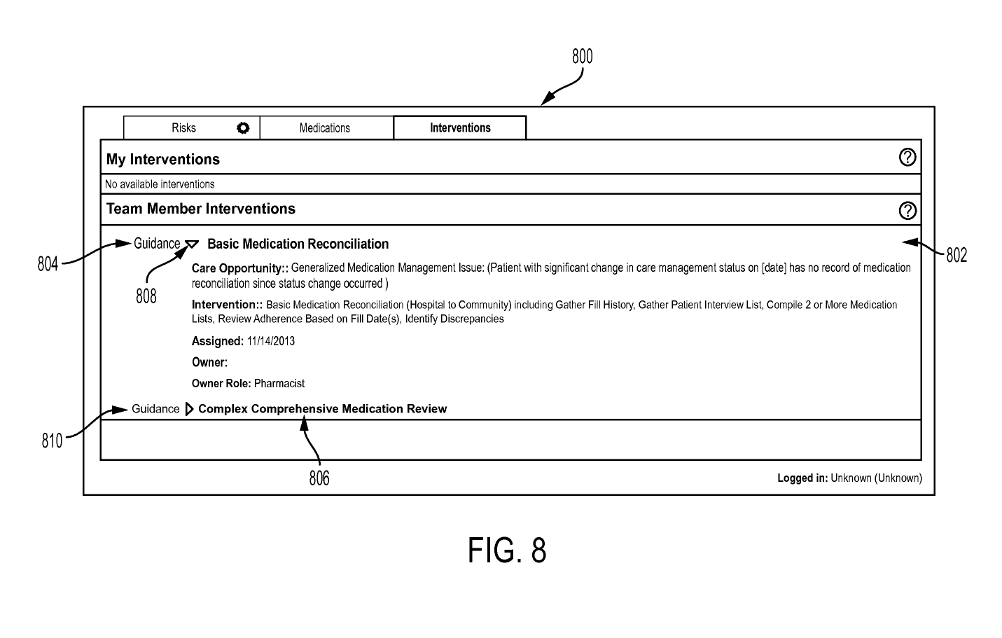

FIG. 8 is an example of a GUI 800 for indicating logistical information according to some aspects. The GUI 800 can include a “My Interventions” section and a “Team Member Interventions” section. The “My Interventions” section can include interventions the user has been assigned to administer to the patient. The “Team Member Interventions” section can include interventions that other members on the user's healthcare team have been assigned to administer to the patient.

In the example shown in FIG. 8, the GUI 800 includes intervention information 802 in the “Team Member Interventions” section. The intervention information 802 can include a list 804 of possible intervention options. Each intervention option can include a summary 806 of the intervention (e.g., “Basic Medication Reconciliation” or “Complex Comprehensive Medication Review”). An icon 808 (e.g., an arrow icon) can be positioned adjacent to the summary 806. A user can interact with the icon 808 to show or hide information associated with the intervention option. The information can include, for example, a care opportunity, a suggested intervention, a date the intervention was assigned to a healthcare professional, an owner, and the owner's role. In some examples, a category 810 (e.g., “Guidance”) associated with the intervention option can be positioned adjacent to the icon 808.

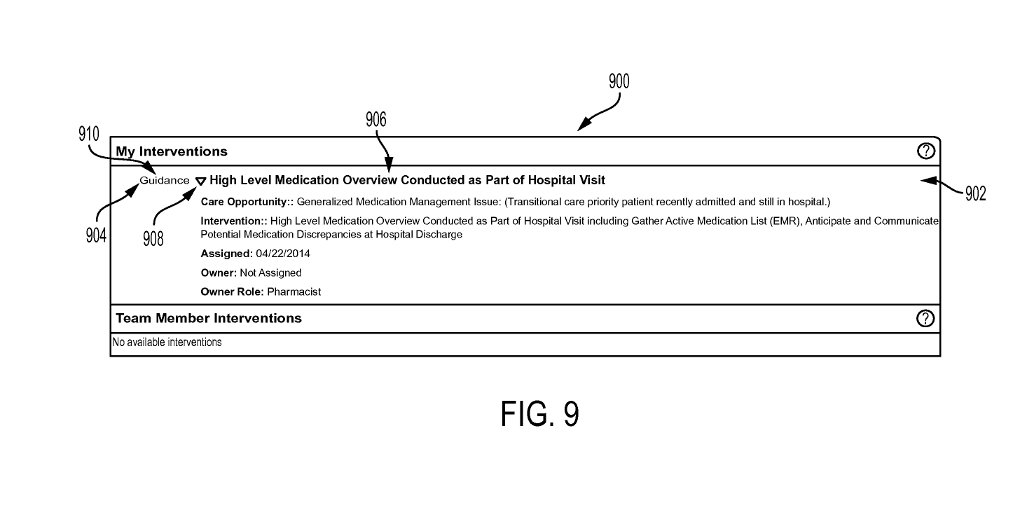

Referring now to FIG. 9, in some examples, a GUI 900 can display intervention information 902 in the “My Interventions” section. The intervention information 902 can include a list 904 of possible intervention options. Each intervention option can include a summary 906, an icon 908, and a category 910 configured substantially the same as for the “Team Member Interventions” section described above with respect to FIG. 8. For example, the icon 908 can be manipulated by a user to show or hide information (e.g., a care opportunity, a suggested intervention, a date the intervention was assigned to a healthcare professional, an owner, and the owner's role) associated with an intervention option.

In some examples, a GUI (e.g., GUI 600, 700, 800, 900) may allow healthcare providers to access, understand, and take action with respect to such information quickly and easily. For example, the GUI may minimize the number of operations the healthcare provider must perform on a computing device to retrieve, interpret, and implement corrective options. The reduced number of operations can improve the functioning of the computing device itself by requiring less memory and fewer processing operations to retrieve and output information to the user. Further, the GUI can improve the functioning of the computing device itself by enhancing the user's ability to interact with the computing device.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device in which instructions executable by the processing device are stored for causing the processing device to:
receive sensor data indicating a physiological characteristic of a patient;
electronically transform the sensor data into a risk score representative of a risk to the patient for a negative outcome by applying the physiological characteristic to at least one predictive model received from a predictive model database;
electronically determine a corrective option for reducing the risk by applying the physiological characteristic to a plurality of rules received from a rules database; and
configure a display device to output a graphical user interface (GUI) comprising the risk score and the corrective option.

2. The system of claim 1, further comprising a sensor configured to transmit the sensor data to the processing device, the sensor comprising a blood pressure sensor, an electrocardiogram (ECG) device, a pressure sensor, a force sensor, a magneto-resistive sensor, a temperature sensor, an oxygen sensor, an X-ray device, a magnetic resonance imaging (MRI) device, a pulse sensor, a galvanic skin response sensor, an airflow sensor, or a heart rate sensor,
wherein the negative outcome comprises a negative healthcare outcome.

3. The system of claim 2, wherein the memory device further comprises instructions executable by the processing device for causing the processing device to:
electronically transform the sensor data into the risk score representative of the risk to the patient for the negative outcome by:
receiving one or more predictive models from the predictive model database, wherein the predictive model database is stored on a first remote server;
selecting the at least one predictive model from the one or more predictive models based on the sensor data;
determining an intermediate score by applying the sensor data to the at least one predictive model;
generating the risk score by calibrating the intermediate score; and
determining a rank for the risk score on a distribution of rankings.

4. The system of claim 3, wherein the memory device further comprises instructions executable by the processing device for causing the processing device to:
electronically determine the corrective option for reducing the risk by:
receiving the plurality of rules from the rules database, wherein the rules database is stored on a second remote server;
receiving a configuration database from a third remote server; and
determining an output of the plurality of rules by applying the physiological characteristic to the plurality of rules; and
determining the corrective option by mapping the output of the plurality of rules to the corrective option using a lookup table of the configuration database.

5. The system of claim 4, wherein the memory device further comprises instructions executable by the processing device for causing the processing device to:
receive a sensor signal indicating the corrective option should be implemented from an input device; and
transmit logistical data to a plurality of remote computer device, the logistical data comprising information for implementing at least a portion of the corrective option.

6. The system of claim 3, wherein the memory device further comprises instructions executable by the processing device for causing the processing device to:
determine the rank for the risk score on the distribution of rankings by:
determining a first rank by comparing the risk score to a first plurality of risk scores associated with a general population; and
determining a second rank by comparing the risk score to a second plurality of risk scores associated with a subset of the general population; and
configure the display device to output two graphs within the GUI, one graph of the two graphs indicating the first rank in comparison to the general population and another graph of the two graphs indicating the second rank in comparison to the subset of the general population.

7. The system of claim 6, wherein the memory device further comprises instructions executable by the processing device for causing the processing device to:
configure the display device to output the risk score in a color and within a shape comprising a different color; and
configure the display device to output the corrective option within the GUI, wherein the corrective option comprises a summary of a care opportunity, another summary of the corrective option, a date that at least a portion of an implementation of the corrective option was assigned to a particular healthcare provider, and a role for the particular healthcare provider in the implementation of the corrective option.

8. The system of claim 1, wherein the memory device further comprises instructions executable by the processing device for causing the processing device to:
determine that the corrective option comprises gathering additional information;
receive the additional information;
electronically transform the additional information into a new risk score; and
electronically determine a new corrective option based on the additional information.

9. A method comprising:
receiving sensor data indicating a physiological characteristic of a patient;
electronically transforming the sensor data into a risk score representative of a risk to the patient for a negative outcome by applying the physiological characteristic to at least one predictive model received from a predictive model database;
electronically determining a corrective option for reducing the risk by applying the physiological characteristic to a plurality of rules received from a rules database; and
configuring a display device to output a graphical user interface (GUI) comprising the risk score and the corrective option.

10. The method of claim 9, further comprising:
receiving the sensor data from a sensor comprising a blood pressure sensor, an electrocardiogram (ECG) device, a pressure sensor, a force sensor, a magneto-resistive sensor, a temperature sensor, an oxygen sensor, an X-ray device, a magnetic resonance imaging (MRI) device, a pulse sensor, a galvanic skin response sensor, an airflow sensor, or a heart rate sensor,
wherein the negative outcome comprises a negative healthcare outcome.

11. The method of claim 10, further comprising:
electronically transforming the sensor data into the risk score representative of the risk to the patient for the negative outcome by:
receiving one or more predictive models from the predictive model database, wherein the predictive model database is stored on a first remote server;
selecting the at least one predictive model from the one or more predictive models based on the sensor data;
determining an intermediate score by applying the sensor data to the at least one predictive model;
generating the risk score by calibrating the intermediate score; and
determining a rank for the risk score on a distribution of rankings.

12. The method of claim 11, further comprising:
electronically determining the corrective option for reducing the risk by:
receiving the plurality of rules from the rules database, wherein the rules database is stored on a second remote server;
receiving a configuration database from a third remote server;
determining an output of the plurality of rules by applying the physiological characteristic to the plurality of rules; and
determining the corrective option by mapping the output of the plurality of rules to the corrective option using a lookup table of the configuration database.

13. The method of claim 12, further comprising:
Receiving a sensor signal indicating the corrective option should be implemented from an input device; and
transmitting logistical data to a plurality of remote computer device, the logistical data comprising information for implementing at least a portion of the corrective option.

14. The method of claim 11, further comprising:
determining the rank for the risk score on the distribution of rankings by:
determining a first rank by comparing the risk score to a first plurality of risk scores associated with a general population; and
determining a second rank by comparing the risk score to a second plurality of risk scores associated with a subset of the general population; and
configuring the display device to output two graphs within the GUI, one graph of the two graphs indicating the first rank in comparison to the general population and another graph of the two graphs indicating the second rank in comparison to the subset of the general population.

15. The method of claim 14, further comprising:
configuring the display device to output the risk score in a color and within a shape comprising a different color; and
configuring the display device to output the corrective option within the GUI, wherein the corrective option comprises a summary of a care opportunity, another summary of the corrective option, a date that at least a portion of an implementation of the corrective option was assigned to a particular healthcare provider, and a role for the particular healthcare provider in the implementation of the corrective option.

16. The method of claim 9, further comprising:
determining that the corrective option comprises gathering additional information;
receiving the additional information;
electronically transforming the additional information into a new risk score; and
electronically determining a new corrective option based on the additional information.

17. A non-transitory computer readable medium comprising program code that is executable by a processing device for causing the processing device to:
receive sensor data indicating a physiological characteristic of a patient;
electronically transform the sensor data into a risk score representative of a risk to the patient for a negative outcome by applying the physiological characteristic to at least one predictive model received from a predictive model database;
electronically determine a corrective option for reducing the risk by applying the physiological characteristic to a plurality of rules received from a rules database; and
configure a display device to output a graphical user interface (GUI) comprising the risk score and the corrective option.

18. The non-transitory computer readable medium of claim 17, further comprising program code executable by the processing device for causing the processing device to:
receive the sensor data from a sensor comprising a blood pressure sensor, an electrocardiogram (ECG) device, a pressure sensor, a force sensor, a magneto-resistive sensor, a temperature sensor, an oxygen sensor, an X-ray device, a magnetic resonance imaging (MRI) device, a pulse sensor, a galvanic skin response sensor, an airflow sensor, or a heart rate sensor,
wherein the negative outcome comprises a negative healthcare outcome.

19. The non-transitory computer readable medium of claim 18, further comprising program code executable by the processing device for causing the processing device to:
electronically transform the sensor data into the risk score representative of the risk to the patient for the negative outcome by:
receiving one or more predictive models from the predictive model database, wherein the predictive model database is stored on a first remote server;
selecting the at least one predictive model from the one or more predictive models based on the sensor data;
determining an intermediate score by applying the sensor data to the at least one predictive model;
generating the risk score by calibrating the intermediate score; and
determining a rank for the risk score on a distribution of rankings.

20. The non-transitory computer readable medium of claim 19, further comprising program code executable by the processing device for causing the processing device to:
electronically determine the corrective option for reducing the risk by:
receiving the plurality of rules from the rules database, wherein the rules database is stored on a second remote server;
receiving a configuration database from a third remote server;
determining an output of the plurality of rules by applying the physiological characteristic to the plurality of rules; and
determining the corrective option by mapping the output of the plurality of rules to the corrective option using a lookup table of the configuration database.

21. The non-transitory computer readable medium of claim 20, further comprising program code executable by the processing device for causing the processing device to:
receive a sensor signal indicating the corrective option should be implemented from an input device; and
transmit logistical data to a plurality of remote computer device, the logistical data comprising information for implementing at least a portion of the corrective option.

22. The non-transitory computer readable medium of claim 19, further comprising program code executable by the processing device for causing the processing device to:
determine the rank for the risk score on the distribution of rankings by:
determining a first rank by comparing the risk score to a first plurality of risk scores associated with a general population; and
determining a second rank by comparing the risk score to a second plurality of risk scores associated with a subset of the general population; and
configure the display device to output two graphs within the GUI, one graph of the two graphs indicating the first rank in comparison to the general population and another graph of the two graphs indicating the second rank in comparison to the subset of the general population.

23. The non-transitory computer readable medium of claim 22, further comprising program code executable by the processing device for causing the processing device to:
configure the display device to output the risk score in a color and within a shape comprising a different color; and
configure the display device to output the corrective option within the GUI, wherein the corrective option comprises a summary of a care opportunity, another summary of the corrective option, a date that at least a portion of an implementation of the corrective option was assigned to a particular healthcare provider, and a role for the particular healthcare provider in the implementation of the corrective option.

24. The non-transitory computer readable medium of claim 17, further comprising program code executable by the processing device for causing the processing device to:
determine that the corrective option comprises gathering additional information;
receive the additional information;
electronically transform the additional information into a new risk score; and
electronically determine a new corrective option based on the additional information.
